(19) United States
(12) Patent Application Publication
(10) Pub. No.: US 2011/0277624 A1
(43) Pub. Date: Nov. 17, 2011

(54) Adjustment Device of a Hydrostatic Machine

(75) Inventors: Timo Nafz, Horb (DE); Clemens Krebs, Tuebingen (DE)

(73) Assignee: Robert Bosch GmbH, Stuttgart (DE)

(21) Appl. No.: 13/146,101

(22) PCT Filed: Jan. 26, 2010
(86) PCT No.: PCT/EP2010/000434

§ 371 Date: Jul. 25, 2011

(30) Foreign Application Priority Data
Jan. 27, 2009 (DE) 10 2009 006 288.

(51) Int. Cl. F15B 13/16

(52) U.S. Cl. 91/358 R

(57) ABSTRACT

An adjustment device according to the disclosure of a hydrostatic machine comprises at least one adjusting piston, a control valve and a follower which is attached between the adjusting piston and control valve and couples the position of the adjusting piston back to the control valve. The follower branches off on the control valve side into two arms that openly surround a component operatively connected to the control valve and are elastically connected to a shaft of the follower.

The invention relates to an adjustment device of a hydrostatic machine.

Hydrostatic machines can often be set in their pumping or displacement volume via an adjustment device. Thus, for example, the pumping or displacement volume of axial piston machines can be set via the angle of a pivotable swash plate. In this case, the adjustment device has at least one adjusting piston, the application of pressure to said adjusting piston being activated via a control valve. The control force of the control valve is to be directly proportional to the volume to be set and is thus also to be directly proportional to the position of the adjusting piston.

The position of the adjusting piston is therefore fed back to the control valve by a driver connected to the adjusting piston.

German Patent DE 100 63 525 B4 discloses such an adjustment device. The driver is in this case designed on the valve side as a slotted lug which encloses a spring sleeve of the control valve. The position of the driver can be set when being mounted on the spring sleeve and is fixed by clamping together the slotted lug on the side facing away from the adjusting piston. On the side of the adjusting piston, the driver is designed in a T shape and is rigidly connected to the adjusting piston of the adjustment device via a screw and two pins.

A disadvantage with the adjustment device described is that the driver is difficult to mount on both the valve side and the adjusting piston side. The slotted lug of the driver must also be additionally oriented relative to the spring sleeve on the valve side, so that the force applied to a valve piston corresponds to a correct pumping or displacement volume, and must then be fastened. This is both time-consuming and susceptible to errors. Even when the driver is pre-mounted in the control valve unit, the driver must still be screwed to the adjusting piston. In addition, the material cost and the weight of such a driver are very high.

The object of the invention is to remove the disadvantages described and in particular to ensure simple and rapid mounting of the driver.

The object is achieved by an inventive adjustment device as claimed in claim 1. The adjustment device of a hydrostatic machine has at least one adjusting piston, a control valve and a driver which is arranged between the adjusting piston and the control valve and which feeds back the position of the adjusting piston to the control valve. The driver branches on the control valve side into two arms which enclose in an open manner a component operatively connected to the control valve and which are connected to a stiff shank region of the driver in an elastically deformable manner.

As a result of such an adjustment device, the driver can be mounted during the assembly of the adjustment device by simply pressing the opening between the two ends of the arms onto a component of the control valve. The arms of the driver are elastically pressed apart by the pressure and the component can thus slip into the enlarged opening produced by the arms. A simple solution, which can be set up in a time-saving manner, for the feedback of the adjusting piston to a control valve is thus achieved. No screws and thus no associated complicated screwing operations are necessary for this purpose.

The dependent claims relate to advantageous developments of the invention.

The driver preferably has, between the stiff shank region and the arms, an elastic shank region formed by incorporating a slot.

It is especially advantageous to fix a locating device for the arms of the driver on the control valve in a mounting or dismounting position relative to a valve housing of the control valve by a holding element. As a result, a preassembled control valve only has to be put onto a driver mounted on the adjusting piston without having to orient the position of the driver with respect to the control valve or the adjusting piston while putting on said control valve.

Furthermore, it is advantageous to fasten the driver in a hole in the adjusting piston by a snap ring which is attached to the driver shank and which sits in a corresponding groove in the hole. As a result, the driver can be fixed in the hole in the adjusting piston by simple insertion of the driver and the snap ring thereof. The feedback of the position of the adjusting piston is established by the hole in the adjusting piston and the mounting position of the locating device and no longer has to be set by a complicated orientation of the driver.

Furthermore, it is advantageous for the two opposite outer sides of the shank of the driver to be flattened. This makes it easier to press the two arms of the driver apart, since the flat reduces the resistance when inserting the locating device into the opening between the driver arms. At the same time, guide surfaces which form a mounting aid are formed on the shank.

A further advantageous development of the invention is to flatten the inner sides of the ends of the arms which form the opening, such that the arms open during the mounting operation.

A preferred exemplary embodiment of the adjustment device according to the invention is shown in the drawing and explained in more detail in the description below. In the drawing:

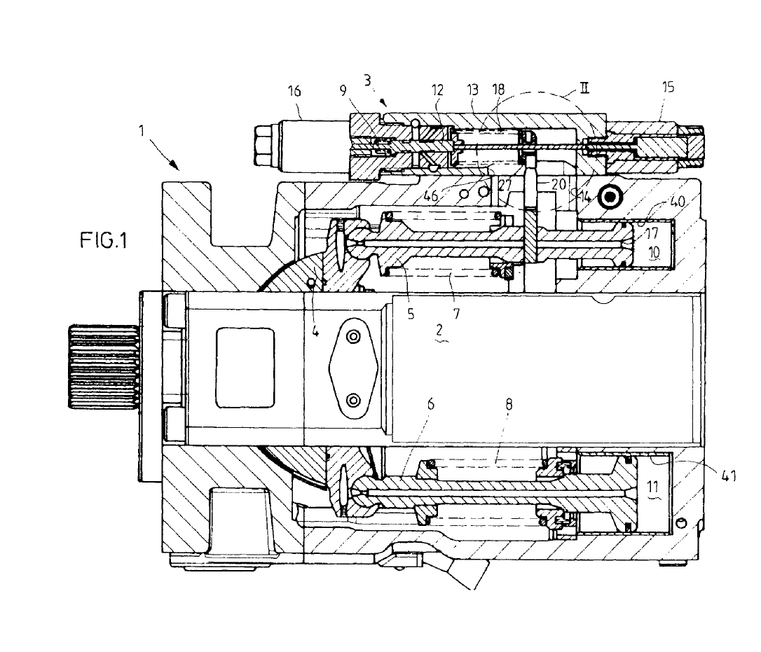

FIG. 1 shows a partial section through an exemplary embodiment of the adjustment device according to the invention of a hydrostatic axial piston machine;

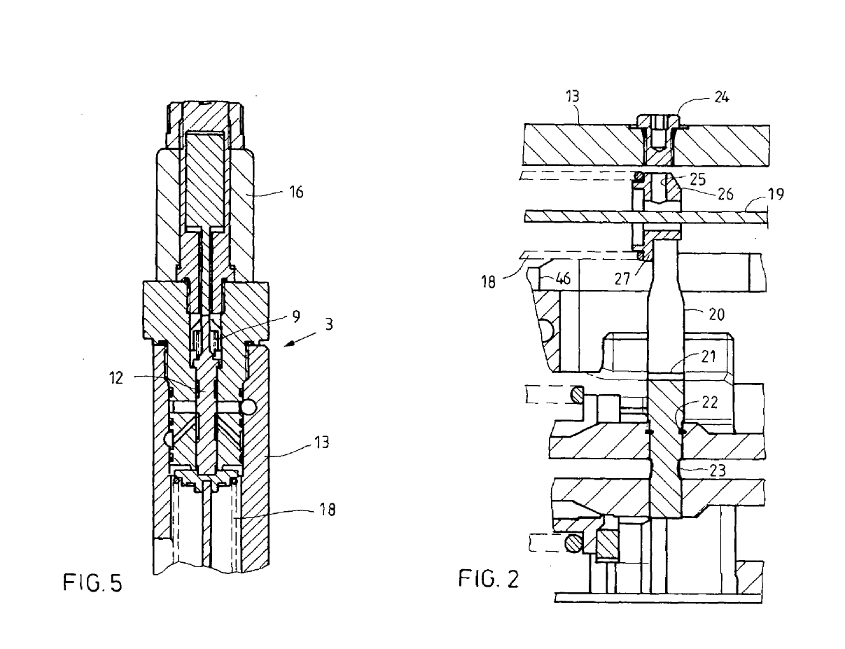

FIG. 2 shows an enlargement of the driver of the exemplary embodiment of the adjustment device according to the invention from FIG. 1;

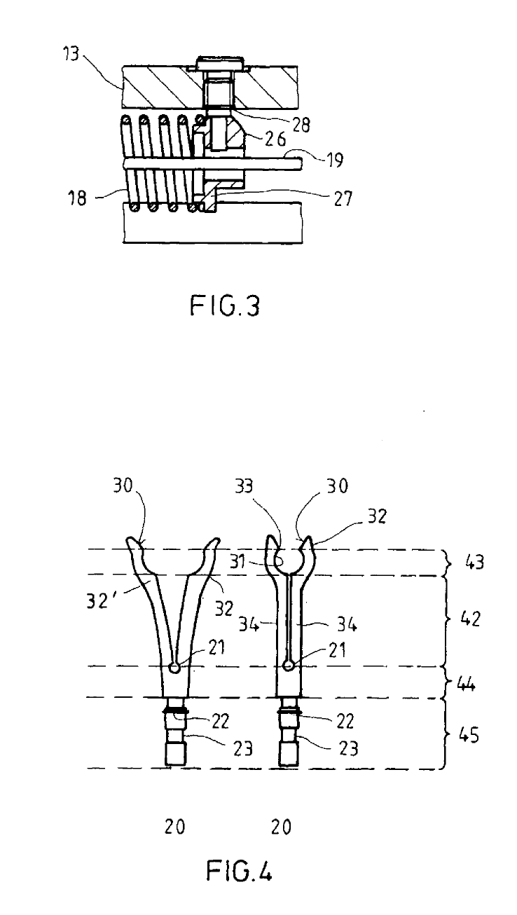

FIG. 3 shows an exemplary embodiment of the control valve of the adjustment device according to the invention in the mounted or dismounted state;

FIG. 4 shows two front views of the driver of the exemplary embodiment of the adjustment device according to the invention; and

FIG. 5 shows an enlargement of the control valve of the exemplary embodiment of the adjustment device according to the invention.

FIG. 1 shows a partial section through an adjustment device 1 of a hydrostatic axial piston machine 2 having an adjustable swash plate 4 for setting a pumping or displacement volume of the axial piston machine 2. The hydrostatic machine can be embodied as both a motor and a pump and is not just restricted to axial piston machines. The invention is suitable for all adjustable hydrostatic machines 2 whose pumping or displacement volume can be set via at least one adjusting piston 5.

In the exemplary embodiment shown in FIG. 1, the swash plate 4 is adjusted via two adjusting pistons 5 and 6. The adjusting pistons 5 and 6 are arranged in an axially displaceable manner in respective adjusting cylinders 40 and 41 and are mechanically coupled to the swash plate 4 as adjustment mechanism of the hydrostatic machine 2. In the adjusting cylinders 40 and 41, with their adjusting pistons 5 and 6, which run out as plungers, both adjusting pistons 5 and 6 each close a respective adjusting pressure space 10 or 11. The adjusting pistons 5 and 6 can be moved axially by regulating the pressure in at least one of the adjusting pressure spaces 10 and 11, in the course of which a pressure force has to be applied in each case to the adjusting pistons 5 and 6 against a spring force of the springs 7 and 8, said spring force always pressing the two adjusting pistons 5 and 6 in the direction of a neutral position of the axial piston machine 2. The axial piston machine 2 is therefore in its neutral position when it is at zero pressure. The adjustment device according to the invention is not restricted to spring-loaded adjusting pistons but can also have, in an alternative exemplary embodiment, one or more springless adjusting pistons.

The two adjusting pistons 5 and 6 each form a spherical head on the piston end pointing toward the swash plate, each spherical head being attached in a ball joint receptacle of a connecting element of the swash plate 4. A longitudinal bore 17 from the adjusting pressure space 10 into the adjusting piston head permits lubrication and hydrostatic relief of the ball joint. Since the swash plate 4 is mounted centrally and the two adjusting pistons 5 and 6 are attached on two sides of the swash plate 4, the adjusting pistons 5 and 6 must be acted upon and moved in opposite directions in order to adjust the angle of the swash plate 4.

In this case, the deflecting adjusting cylinder 41 has a larger cross-sectional area than the opposing adjusting cylinder 40, for which reason the deflecting piston 6 also has a larger surface to which pressure is applied than the opposing piston 5. As a result, a constant high pressure, e.g. the pump pressure, can be applied to the opposing piston 5, and a lower control pressure which sets the desired swash plate angle can be applied to the deflecting piston 6. However, this is not restrictive for the invention and both adjusting pistons 5 and 6 can also be the same size and be acted upon by a variable control pressure.

The control pressure is set via a control valve 3. The control valve 3 has a control element which, as in the exemplary embodiment, is preferably embodied as a control piston 12. The control piston 12 is mounted in an axially movable manner in the valve housing 13 between a spring 9 on a first side of the control piston 12 and a feedback spring 18 on an opposite second side. The neutral position of the control piston 12 can be set by the preloading of the spring 9. The feedback spring 18 is arranged between a first spring support, sitting on the second side of the control piston 12, and a second spring support 27, as can be seen in the enlargements in FIGS. 2 and 5. The second spring support 27 and the opposing piston 5 are mechanically coupled via a driver 20. The position of the second spring support 27 is thus established according to the position of the opposing piston 5 and a force of the feedback spring 18 is therefore exerted on the control piston 12, said force being directly or virtually directly proportional to the position of the opposing piston 5. In addition to being acted upon by the spring 9 on the first side, the control piston 12 can be acted upon by a force produced by a first proportional magnet 16. On the second side, in addition to being acted upon by the feedback spring 18, the control piston 12 can be acted upon by a force produced by a second proportional magnet 15. When all the forces acting on the control piston 12 are in equilibrium, the control piston is in its control position. When the magnets are de-energized, this control position is the neutral position.

The control piston can be displaced between two end positions from a control position by varying the forces of the proportional magnets 15 and 16. In the exemplary embodiment, the proportional magnet 16 can act upon the control piston 12 directly on the first side. On the second side, the control piston 12 can be acted upon by a second proportional magnet 15 via a rod 19. If the control piston 12 is deflected from its control position in the direction of the first side (on the left in FIG. 1) by a force of the proportional magnet 15, the adjusting pressure chamber 11 is connected to a high pressure and thus the pressure in the adjusting pressure chamber 11 is increased. This leads to an increased force on the deflecting piston 6 and thus to a displacement of the deflecting piston 6 in the direction of the swash plate and to a displacement of the opposing piston 5 in the direction of the adjusting cylinder 40, since the pressure in the adjusting pressure chamber 10 remains constant. This results in a displacement of the angle of the swash plate 4, but also results in a displacement of the driver 20 against the deflection direction of the control piston 12. This leads to lower loading of the feedback spring 18 and thus to a reduction in the force on the second side of the control piston 12. The control piston 12 therefore remains deflected only until a new equilibrium of forces has occurred. If the equilibrium of forces of the control piston 12 is restored, the control piston 12 is again in its control position.

A resulting force, acting in the opposite direction, on the control piston 12 produces a deflection in the other direction, and this deflection connects the adjusting pressure space 11 to a low-pressure source, e.g. a tank, and lets the pressure out of the adjusting pressure space 11. As a result, the swash plate is pivoted in the opposite direction until the forces acting on the control piston 12 are again in equilibrium.

In production, the control valve 3 and the axial piston machine 2, which normally contains the adjustment mechanism for adjusting the swash plate angle, are preassembled. During assembly, the control valve 3 must then be coupled to the opposing piston 5 via the driver 20. In order to realize this in as simple a manner as possible, a driver 20 was designed according to the invention, as shown in FIG. 4.

The driver 20 branches at a first end 43 into two arms 32, 32′. On their inner sides, the arms 32, 32′ form a circular opening 31 which opens in the direction of the first end of the driver 20. This results in a circular opening 31 that is not closed. The ends of the arms 32 are flattened in such a way that their surfaces 30 are tilted outward by an acute angle starting from the driver axis. This angle is preferably around 45°. As a result, an object pressing on the surfaces 30 causes forces which press the arms 32 apart and which enable said object to snap into place in the opening 31.

An elastic shank section 42 is formed following the arms 32, 32′. The elastic shank section 42 has an elastic behavior transversely to the longitudinal axis of the control valve 3 and a stiff behavior along the valve longitudinal axis. To this end, the shank of the driver is slotted centrally between the two arms 32 up to a hole 21, such that the driver 20 has, in the elastic shank section 42, two flexible shank flanks 34, 34′ which lead into the respective arms 32 at the first end 43. The hole 21 prevents a notch effect when the arms 32, 32′ and the shank flanks 34, 34′ are spread apart. A stiff shank region 44 of the driver 20 is formed after the hole in the direction of the second end. At the second end of the driver 20, in the second fastening section 45, the driver 20 has a stepped radius reduced relative to the stiff shank region 44.

To mount the driver 20 on the opposing piston 5, a hole, the radius of which corresponds to that of the driver 20 in the second fastening region 45, is made in the opposing piston 5. The driver 20 is inserted with the second fastening section 45 through a guide gap 14 in the housing of the axial piston machine 2 into the hole in the opposing piston 5. In the second fastening section 45 inserted into the hole, the driver 20 has a snap ring 22 which, when the second fastening section is completely inserted into the hole, latches in place in a groove and therefore fastens the driver 20 in the opposing piston 5. In the region of the longitudinal bore 17 through the opposing piston 5, the driver 20 has a radial constriction 23 which forms a passage for the hydraulic fluid and thus continues to keep the longitudinal bore 17 open.

The control valve 3 is already preassembled before being arranged on the axial piston machine 2. A gasket is put onto the mounting surface of the control valve 3 on the axial piston machine 2, and the control valve 3 is put onto the mounting surface of the axial piston machine 2. In the process, the driver 20, the first end of which projects from the guide gap 14 of the axial piston machine 2, must be inserted into the driver opening 46 in the valve housing 13. The second spring support 27 has an approximately cylindrical locating device 26, the cross section of which corresponds to the cross section of the opening 31 of the driver 20. The control valve is now pushed onto the driver 20 in such a way that the opening 31 bears against the locating device 26 of the second spring support 27. By the exertion of a certain force on the control valve 3 and thus on the locating device 26, the locating device 26 presses on the flattened sides 30 of the arms 32, 32′. This produces an outwardly acting force on the arms 32, 32′ and the shank flanks 34, 34′ connected thereto, as shown exaggerated on the left in FIG. 4. By the arms 32, 32′ being bent apart, which are elastically connected to the robust shank region 44 via the shank flanks 34, 34′, the passage opening 33 is widened until it reaches the maximum diameter of the locating device 26 and the latter can slip into the opening 31. If the locating device 26 is located completely in the opening 31, the arms 32, 32′ return into their original position and surround the locating device 26 over more than half the periphery. The spring support 27 is pressed against the driver 20 by the pressure of the feedback spring 18 and thus provides a fixed coupling between the opposing piston 5, via the driver 20, the spring support 27 and the feedback spring 18, on the control piston 12.

So that the locating device 26 is located in a mounting position upon insertion into the opening 31, the spring support 27 is fixed in the preassembled control valve 3 by a mounting screw 28 as holding element, as shown in FIG. 3. To this end, a hole is made in the spring retainer 27, said hole being oriented in such a way that it lies exactly between the arms 32, which largely surround the locating device 26. A hole is drilled through the valve housing 13 in such a way that this hole meets the hole in the second spring support 27 in the mounting position. The spring retainer 27 can be held in the mounting position by a mounting or dismounting screw or a pin through the two holes. A mounting position is in this case a position of the spring retainer 27 in which the locating device 26 is located at the same level with the mounted driver 20 when the control valve 3 is mounted and is not electromagnetically loaded, wherein the opposing piston 5, on which the driver 20 is mounted, is not acted upon by pressure during the mounting and is located in its neutral position.

If the arms 32, 32′ of the driver 20 are latched in place on the locating device 26, the control valve 3 can be screwed to the axial piston machine 2 and the mounting screw 28 can be replaced by a plug 24, as shown in FIG. 1 and FIG. 2. For the dismounting, the plug 24 is again replaced by a dismounting screw in order to prevent displacement of the spring support 27 from the mounting position when the control valve 3 is removed. The mounting or dismounting screw fixes the locating device 26 both in the direction of the valve longitudinal axis and in the directions transversely to the valve longitudinal axis.

The material of the driver 20 has to be selected in such a way that it permits an elastic deformation of the arms 32 and in particular of the shank flanks 34 without a plastic deformation until the distance between the two flattened ends of the arms 32, 32′ corresponds to the maximum diameter of the locating device. At the same time, it should withstand the spring forces of the feedback spring 18 and be elastically deformed as little as possible in order to transmit the position of the opposing piston 5 as directly as possible.

The driver 20 can be additionally fixed in the axial direction of the control piston 12 by a closure (not shown in the figures) of the locating device 26. To this end, a locating device closure can be designed in such a way that the locating device 26 widens radially after a locating region for the driver 20 in order to prevent an axial displacement of the driver 20. This is only an additional protection against slipping of the driver 20 since the driver 20 is already pressed against the spring support 27 by the loading of the feedback spring 18. Reliable fixing of the locating element 26 in the opening 31 is thus ensured even in the event of a spring breaking.

Alternatively, the driver 20 can also be attached to the deflecting piston 6. The control valve 3 would only have to be appropriately adapted to the reversal of direction of the feedback of the adjusting piston position.

The opening 31 need not be circular, but rather only has to correspond to the shape of the locating device 26 of the spring retainer 27. Furthermore, the opening 31 of the driver 20 should be suitable for bending the arms 32, 32′ outward solely by being pressed onto the locating device 26 and for fixing the locating device 26 after the latter is accommodated in the opening 31. The opening 31 therefore has to be designed in such a way that the passage opening 33 is so much narrower than the maximum part, to be moved through the passage opening 33, of the locating device 26 that the arms 32, when they surround the locating device 26 in an open manner, hold the locating device 26 in place. On the other hand, the passage opening 33 must still be so large that solely the pressure of the locating device 26 on the passage opening 33 is sufficient to press the arms 32 apart. That is to say that, after the passage opening 33, the opening 31 widens to a maximum diameter and narrows again. The expression “enclose in an open manner” or “surround in an open manner” means, in connection with the present invention, that the driver 20 branches into two arms 32, 32′ which hold a locating device 26 in place, the ends of the two arms 32, 32′ forming a passage opening 33. This means that the ends of the two arms 32, 32′ on the first side of the driver 2 do not touch one another.

The invention is not restricted to the exemplary embodiment shown. On the contrary, individual features of the adjustment device according to the invention can also be combined in an advantageous manner.

1. An adjustment device of a hydrostatic machine, comprising:
at least one adjusting piston including a control valve and a driver which is arranged between the adjusting piston and the control valve and which feeds back the position of the adjusting piston to the control valve,
wherein the driver branches on the control valve side into two arms which enclose in an open manner a component operatively connected to the control valve and which are connected to a stiff shank region in an elastically deformable manner.

2. The adjustment device as claimed in claim 1, wherein the driver has, between the stiff shank region and the arms, an elastic shank region formed by slotting the shank.

3. The adjustment device as claimed in claim 1, wherein:
the control valve has a feedback spring which sits in a spring support, and
the arms enclose a locating device of the spring support.

4. The adjustment device as claimed in claim 3, wherein the feedback spring presses the spring retainer against the driver.

5. The adjustment device as claimed in claim 3, wherein the driver can be fixed between the spring support and a radially extended locating device closure.

6. The adjustment device as claimed in claim 3, wherein the locating device has a hole which lies between the open ends of the two arms of the driver.

7. The adjustment device as claimed in claim 3, wherein the locating device is configured to be fixed in a mounting position or a dismounting position relative to a valve housing of the control valve by a holding element.

8. The adjustment device as claimed in claim 1, wherein:
a snap ring is attached to the driver, and
the driver can be fastened in a groove of a hole in the adjusting piston by the snap ring.

9. The adjustment device as claimed in claim 1, wherein the driver is made of an elastically deformable material which ensures that the two ends of the open arms of the driver are spread apart to the maximum diameter of the locating device without plastic deformation of the material.

10. The adjustment device as claimed in claim 1, wherein the inner sides of the ends of the arms are flattened.

11. The adjustment device as claimed in claim 1, wherein two opposite outer sides of the shank of the driver are flattened.

12. The adjustment device as claimed in claim 1, wherein the flats run parallel to a slot forming two shank flanks.
